(19) United States
(12) Patent Application Publication
(10) Pub. No.: US 2010/0033288 A1
(43) Pub. Date: Feb. 11, 2010

(54) Thin inductor, method of producing the thin inductor, and ultra small size power conversion apparatus using the thin inductor

(75) Inventors: Takeshi Yokoyama, Matsumoto (JP); Takafumi Yamada, Matsumoto City (JP); Tomonori Seki, Azumino City (JP); Masaharu Edo, Tokorozawa City (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd., Tokyo (JP)

(21) Appl. No.: 12/458,426

(22) Filed: Jul. 10, 2009

(30) Foreign Application Priority Data
Jul. 24, 2008 (JP) 2008-190896

(51) Int. Cl. H01F 5/00; H01F 41/00

(52) U.S. Cl. 336/200; 29/602.1

(57) ABSTRACT

Two coil conductors of the same spiral shape are cut out from a lead frame. The two coil conductors are disposed back to back so that the front of a first coil conductor is superimposed over the rear of a second coil conductor. Central end portions of the first and second coil conductors are connected to each other through a connection layer. Outer end portions of the spirals of the first and second coil conductors are connected to corresponding ones of first and second terminals of the thin inductor, respectively. A sintered green sheet as a magnetic substance is disposed in gaps between the first and second coil conductors. In this manner, the invention can provide a thin inductor small in size, strong in mechanical strength and inexpensive, a method of producing the thin inductor, and an ultra small size power conversion apparatus using the thin inductor.

### BACKGROUND OF THE INVENTION

1. Field of the Invention

The present invention relates to a thin inductor using spiral lead frames as coils, a method of producing the thin inductor, and an ultra small size power conversion apparatus using the thin inductor.

2. Description of the Background Art

An ultra small size power conversion apparatus such as a micro power supply according to the background art has a structure in which after a semiconductor chip is mounted, by flip chip bonding or by an adhesive agent or the like, on a substrate of a thin inductor having a coil pattern made of a ferrite material as a base plated with copper, the semiconductor chip is connected to terminals of the thin inductor by bonding wire such as gold wire, copper wire, silver wire, aluminum wire, etc. and sealed with resin.

FIGS. 13A and 13B show the configuration of the thin inductor according to the background art. FIG. 13A is a plan view showing part of the thin inductor. FIG. 13B is a sectional view of this part taken along the line X-X in FIG. 13A. The thin inductor includes a ferrite substrate 51, coil conductors 52 and terminals 53 formed on front and rear surfaces of the ferrite substrate 51, and connection conductors 54 for connecting the coil conductors 52 to each other and the terminals 53 to each other between the front and rear surfaces of the ferrite substrate 51. The connection conductors 54 are formed in such a manner that through holes 55 are formed in the ferrite substrate 51 and metal films are formed on side walls of the through holes 55 respectively (FIGS. 13A and 13B show the case where the through holes 55 are filled with the metal films respectively). The coil shape of the thin inductor is of a solenoid shape.

FIGS. 14 and 15 are sectional views of the part of the thin inductor corresponding to FIG. 13B, showing ultra small size power conversion apparatuses each formed by use of the thin inductor depicted in FIGS. 13A and 13B. In FIG. 14, a semiconductor chip 56 is connected to terminals 53 of a thin inductor by bumps 57, and sidewalls of the semiconductor chip 56 are covered with underfills 58.

In FIG. 15, a semiconductor chip 56 is connected to coil conductors 52 with adhesive tape 60, and connected to terminals 53 of a thin inductor by bonding wires 61 and a surface of the semiconductor chip 56 is covered with a sealing resin 62. An opposite surface including coil conductors 52 is sealed with protective film 59.

FIG. 16 is a plan view showing the same part of the thin inductor in a state where thin inductors are formed on a ferrite substrate. The ferrite substrate 51 is cut along a cut region 65 to thereby separate the thin inductors individually.

FIGS. 17 to 24 are sectional views of the above reference part of the thin inductor successively showing steps of a process for producing the thin inductor according to the background art depicted in FIGS. 13A and 13B.

First, a ferrite substrate 51 is prepared (FIG. 17).

Then, the ferrite substrate 51 is masked with a resist 71 so that through holes 55 will be formed in the ferrite substrate 51 (FIG. 18).

Then, the through holes 55 are formed in the ferrite substrate 51 masked with the resist 71. The through holes 55 are formed in such a manner that holes are dug in the front and rear surfaces of the ferrite substrate 51 by a sandblasting technique (FIG. 19).

Then, a plating seed layer 72 is formed on the whole surface of the ferrite substrate 51 and on side surfaces of the through holes 55 (FIG. 20).

Then, the plating seed layer 72 is masked with a resist 73 so that Cu films 74 will be formed as coil conductors 52 and terminals 53 on the plating seed layer 72 (FIG. 21).

Then, the plating seed layer 72 masked with the resist 73 is plated with copper to thereby form the Cu films 74 (FIG. 22).

Then, the resist 73 is removed and an unnecessary part of the plating seed layer 72 is removed to thereby form the coil conductors 52 and the terminals 53 of the Cu films 74 (FIG. 23).

Then, the ferrite substrate 51 is covered with a protective film 75 and cut at parting lines 76 (FIG. 24). Thus, the thin inductor according to the background art is completed.

In this manner, the thin inductor according to the background art is formed by a process of forming through holes 55 in a ferrite material used as a substrate (ferrite substrate 51) by a sandblasting technique and then selectively applying copper-plating on the through holes 55 and front and rear surfaces of the ferrite substrate 51.

A technique in which coil conductors are shaped toroidally and in which a thin inductor is still formed by a process of forming through holes in a ferrite material by a sandblasting technique and selectively applying copper-plating to the through-holes and front and rear surfaces of the ferrite substrate has been disclosed in JP-A-2004-72815.

In the thin inductor produced in this manner according to the background art, the ferrite material used as the substrate is however so brittle that breaking or cracking occurs easily during processing. This causes lowering of the yield rate of good products. Moreover, processing accuracy in formation of the through holes is so poor that it is difficult to reduce the size of the through holes. This is a barrier to reduction of product size.

### SUMMARY OF THE INVENTION

An object of the invention is to provide a thin inductor which is small in size, strong in mechanical strength and inexpensive, a method of producing the thin inductor and an ultra small size power conversion apparatus using the thin inductor in order to solve the aforementioned problems.

To achieve the foregoing object, there is provided a thin inductor using spiral coil conductors of lead frames, including: first and second coil conductors having the same spiral shape and arranged so as to be superimposed over each other with a gap between the first and second coil conductors; a connection layer by which both end portions of the first and second coil conductors are connected to each other; and a magnetic substance which is formed so that the first and second coil conductors are inserted in the magnetic substrate while gaps between parts of the first coil conductor and between parts of the second coil conductor and the gap between the first and second coil conductors are filled with the magnetic substrate.

The thin inductor further includes terminals, which are connected to outer end portions of the spiral-shaped first and second coil conductors.

Preferably, the coil conductors and the terminals may be spiral conductors and rectangular conductors which are each connected to a respective inside frame surrounded by lead frames and which are formed as part of the lead frames in the inside of the lead frame.

Preferably, the terminals may be as thick as the lead frames whereas the coil conductors may be not thicker than the terminals.

Preferably, the thin inductor may include: a spiral coil conductor, which is formed from the lead frames; and a magnetic substance, which is formed so that both ends of the coil conductor are inserted in the magnetic substance.

Preferably, the magnetic substance may be a sintered compact of a green sheet or a sintered compact of magnetic powder.

There is also provided a method of producing a thin inductor, including the steps of: turning over or 180°-rotating one of two lead frames of the same shape having terminals of the same shape and spiral coil conductors of the same shape in inside frames of the same shape to thereby set the turned-over or 180°-rotated lead frame as a second lead frame; forming connection layers on terminals of the second lead frame connected to the inside frame and on the other end portion of the coil conductor located in a central portion of the spiral shape of the coil conductor having one end portion connected to one of the terminals, respectively; fixing central end portions of the two coil conductors to each other and the terminals to each other through the connection layers while superposing the second lead frame on the other lead frame not turned over or not 180°-rotated; inserting the superimposed-over two lead frames in a green sheet; packing the two coil conductors by filling a gap between the coil conductors with the green sheet while applying pressure to the green sheet; sintering the green sheet; and separating the coil conductors and the terminals from the lead frames.

There is further provided a method of producing a thin inductor, including the steps of: turning over or 180°-rotating a first lead frame which is one of two lead frames of the same shape having terminals of the same shape and spiral coil conductors of the same shape in inside frames of the same shape; forming connection layers on terminals of the first lead frame connected to the inside frame and on the other end portion of the coil conductor located in a central portion of the spiral shape of the coil conductor having one end portion connected to one of the terminals, respectively; disposing a first green sheet having opening portions embedded in the connection layers on the coil conductor; connecting central end portions of the spirals of the two coil conductors to each other and the terminals to each other through the connection layers while superposing the first lead frame on the other, second lead frame not turned over or not 180°-rotated; inserting the superimposed-over two lead frames in a second green sheet; packing the two coil conductors by filling a gap between the coil conductors with the first and second green sheets while applying a pressure on the first and second green sheets; sintering the first and second green sheets; and separating the coil conductors and the terminals from the lead frames.

Preferably, the connection layers may be one member selected from the group consisting of laser welding layers, ultrasonic bonding layers, bumps and conductive paste adhesive agent layers.

Preferably, the coil conductors may be thinner than the terminals.

Preferably, an ultra small size power conversion apparatus may be formed in such a manner that a semiconductor chip is fixed onto the thin inductor.

In the ultra small size power conversion apparatus, the semiconductor chip may be connected to the terminals of the thin inductor by bumps or bonding wires.

According to the invention, a processing process for forming through holes can be dispensed with and inexpensive lead frames can be used as coil conductors. Accordingly, mechanical strength is improved so that reduction in size and cost of a thin inductor can be attained.

Use of the thin inductor permits reduction in size and cost of a micro power supply, which is an ultra small size power conversion apparatus.

### BRIEF DESCRIPTION OF THE DRAWINGS

FIG. 1A is a plan view of a part of a thin inductor showing a configuration according to Embodiment 1 of the invention;

FIG. 1B is a sectional view of the same part of the thin inductor taken along the line X-X in FIG. 1A;

FIG. 2A is a plan view showing a configuration of a lead frame 20a not turned over;

FIG. 2B is a plan view showing a configuration of a lead frame 20b turned over;

FIGS. 3A to 3D are sectional views showing successive steps of a method of producing the thin inductor depicted in FIGS. 1A and 1B;

FIG. 4A is a pressure pattern graph in the case where pressure increases with passage of time;

FIG. 4B is a pressure pattern graph in the case where a high pressure is applied after gaps are fully filled with a green sheet under a constant low pressure;

FIG. 5 is a sectional view of part of a thin inductor according to Embodiment 2 of the invention;

FIG. 6 is a sectional view showing a step in a process of producing the thin inductor depicted in FIG. 5;

FIG. 7 is a sectional view of a step the process of the invention following that illustrated in FIG. 6 in the process of producing the thin inductor depicted in FIG. 5;

FIG. 8 is a sectional view showing a step following the step shown in FIG. 7 in the process of producing the thin inductor depicted in FIG. 5;

FIG. 9 is a sectional view showing a step following the step shown in FIG. 8 in the process of producing the thin inductor depicted in FIG. 5;

FIG. 10 is a sectional view showing a step following the step shown in FIG. 9 in the process of producing the thin inductor depicted in FIG. 5;

FIG. 11 is a sectional view of part of a thin inductor according to Embodiment 3 of the invention;

FIG. 12A is a sectional view of part of an ultra small size power conversion apparatus according to Embodiment 4 of the invention in the case where a semiconductor chip is connected to terminals by bumps;

FIG. 12B is a sectional view of part of the ultra small size power conversion apparatus according to Embodiment 4 of the invention in the case where a semiconductor chip is connected to terminals by bonding wires;

FIG. 13A is a plan view of a part showing the configuration of a thin inductor according to the background art;

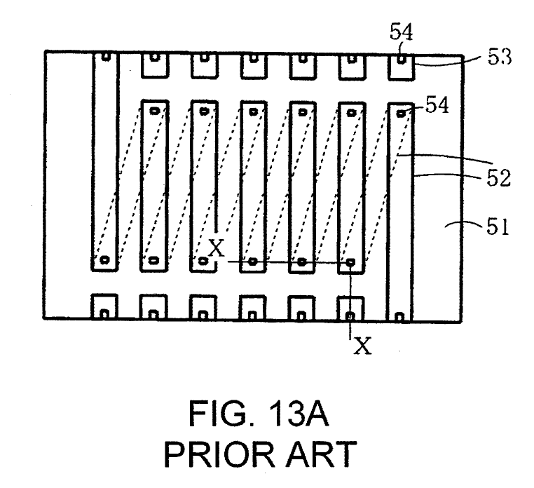

FIG. 13B is a sectional view taken along the line X-X in FIG. 13A;

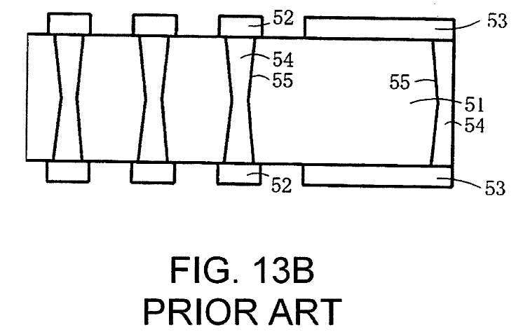

FIG. 14 is a sectional view of part of an ultra small size power conversion apparatus in which a semiconductor chip is connected by bumps to the thin inductor depicted in FIGS. 13A and 13B;

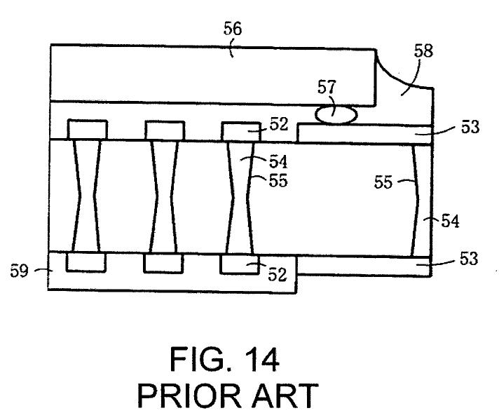

FIG. 15 is a sectional view of part of an ultra small size power conversion apparatus in which a semiconductor chip is connected by bonding wires to the thin inductor depicted in FIGS. 13A and 13B;

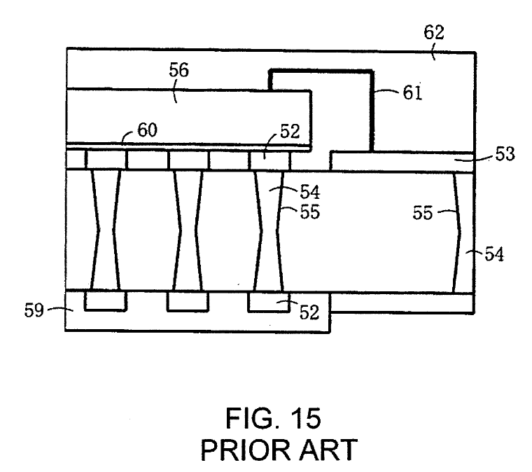

FIG. 16 is a plan view of a part in the case where thin inductors are formed on a ferrite substrate;

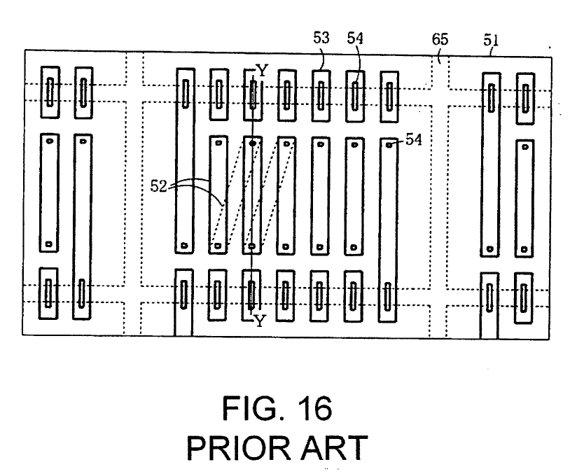

FIG. 17 is a sectional view showing a step in a process of producing the thin inductor depicted in FIGS. 13A and 13B;

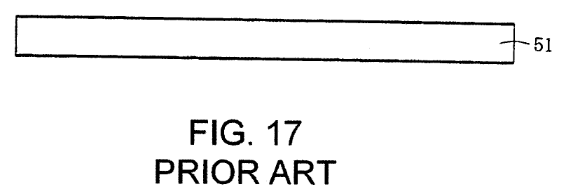

FIG. 18 is a sectional view showing a step following that shown in FIG. 17 in the process of producing the thin inductor depicted in FIGS. 13A and 13B;

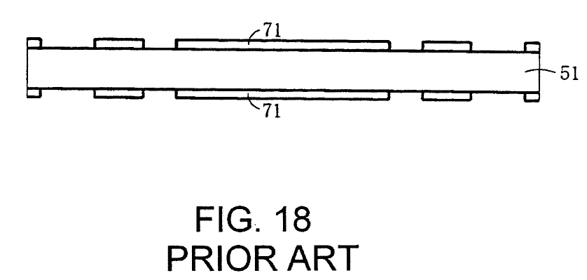

FIG. 19 is a sectional view showing a step following that shown in FIG. 18 in the process of producing the thin inductor depicted in FIGS. 13A and 13B;

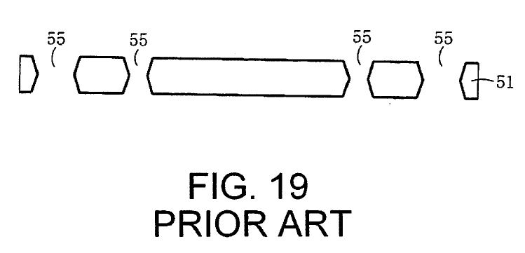

FIG. 20 is a sectional view showing a step following that shown in FIG. 19 in the process of producing the thin inductor depicted in FIGS. 13A and 13B;

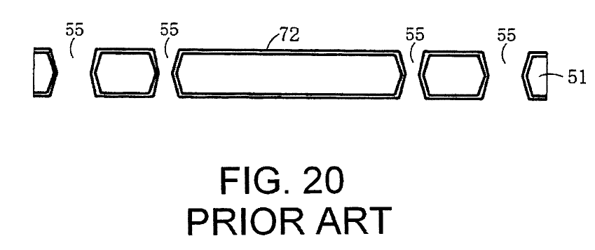

FIG. 21 is a sectional view showing a step following that shown in FIG. 20 in the process of producing the thin inductor depicted in FIGS. 13A and 13B;

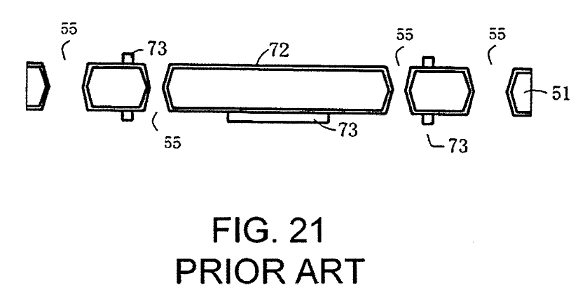

FIG. 22 is a sectional view showing a step following that shown in FIG. 21 in the process of producing the thin inductor depicted in FIGS. 13A and 13B;

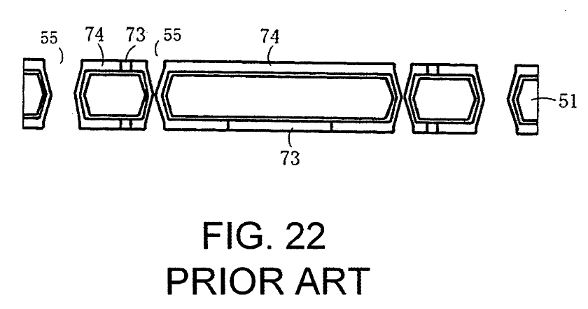

FIG. 23 is a sectional view showing a step following that shown in FIG. 22 in the process of producing the thin inductor depicted in FIGS. 13A and 13B; and

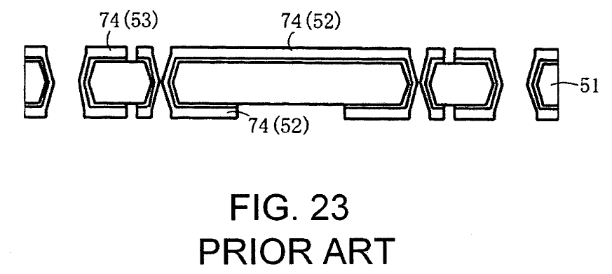

FIG. 24 is a sectional view showing a step following that shown in FIG. 23 in the process of producing the thin inductor depicted in FIGS. 13A and 13B.

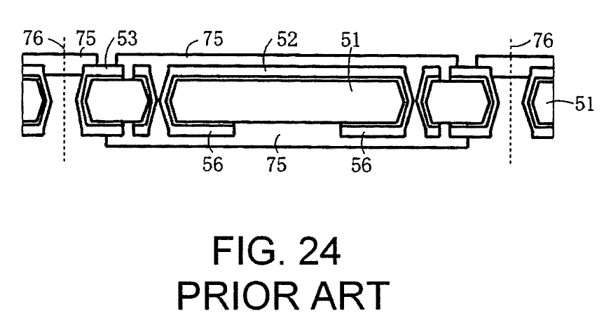

### DETAILED DESCRIPTION OF THE INVENTION

Preferred embodiments of the invention will be described below with reference to the drawings. Incidentally, the same constituent parts as those in the background art structure are referred to by the same numerals.

### Embodiment 1

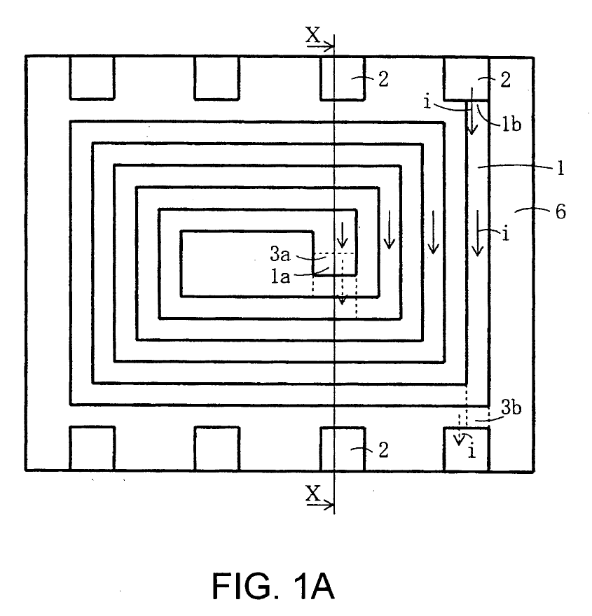

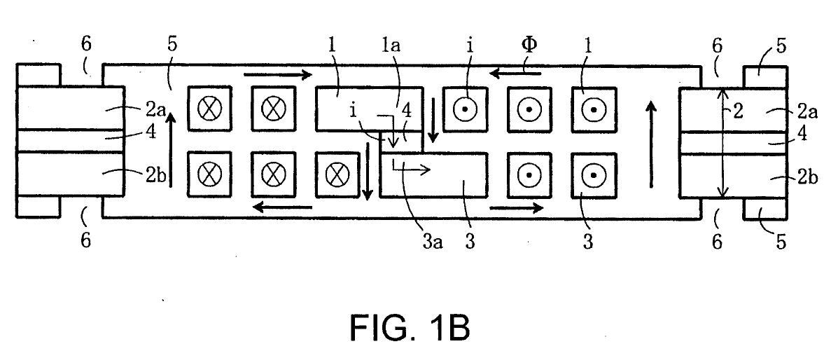

FIGS. 1A and 1B show the configuration of a thin inductor according to Embodiment 1 of the invention. FIG. 1A is a plan view of part of the thin inductor. FIG. 1B is a sectional view of the part taken along the line X-X in FIG. 1A.

Two coil conductors of the same spiral shape are cut out from a lead frame. The two coil conductors are disposed back to back with each other so that a first coil conductor 1 which is one coil conductor not turned over is superimposed over a second coil conductor 3 which is the other coil conductor turned over. Central end portions la and 3a (of the spirals) of the first and second coil conductors 1 and 3 are connected to each other through a connection layer 4. Outer end portions lb and 3b (of the spirals) of the first and second coil conductors 1 and 3 are connected to corresponding ones of first and second terminals 2a and 2b of the thin inductor, respectively. First terminals 2a disposed on an upper surface side of the thin inductor are paired with second terminals 2b disposed on a lower surface side of the thin inductor so as to be superimposed over the first terminals 2a. The first terminals 2a and the second terminals 2b paired with each other and superimposed over each other are connected to each other through connection layers 4 to thereby form terminals 2.

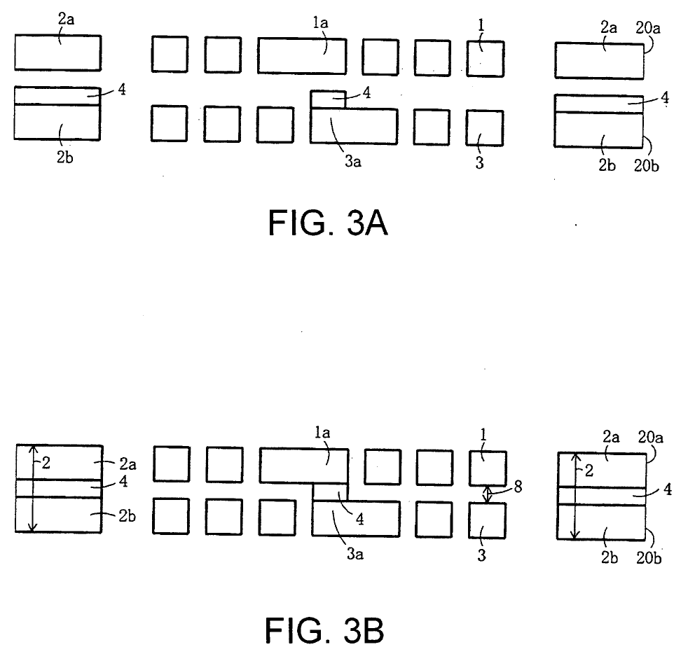

A green sheet 5 of a sintered magnetic substance is disposed both in gaps 7 (see FIG. 3C) formed in each of the first and second coil conductors 1 and 3 and in gaps 8 (see FIG. 3C) between the spiral-shaped first and second coil conductors 1 and 3. The green sheet 5 is a magnetic substance shaped into a sheet from a mixture of magnetized fine powder and resin called ‘binder’ by a doctor blade. When sintered, the green sheet 5 forms a magnetic substrate.

FIGS. 1A and 1B further show the flow directions of current i. Current i flows downward in a right half of FIG. 1A (frontward in a right half of FIG. 1B). Current i flows upward in a left half of FIG. 1A (backward in a left half of FIG. 1B). Magnetic flux Φ through the part also is shown.

Incidentally, the connection layers 4 are one of the following: laser welding layers, ultrasonic bonding layers, bumps and conductive paste adhesive agent layers. The first and second coil conductors 1 and 3 and the first and second terminals 2a and 2b are made of a conductor such as copper (Cu), and are formed as part of lead frames.

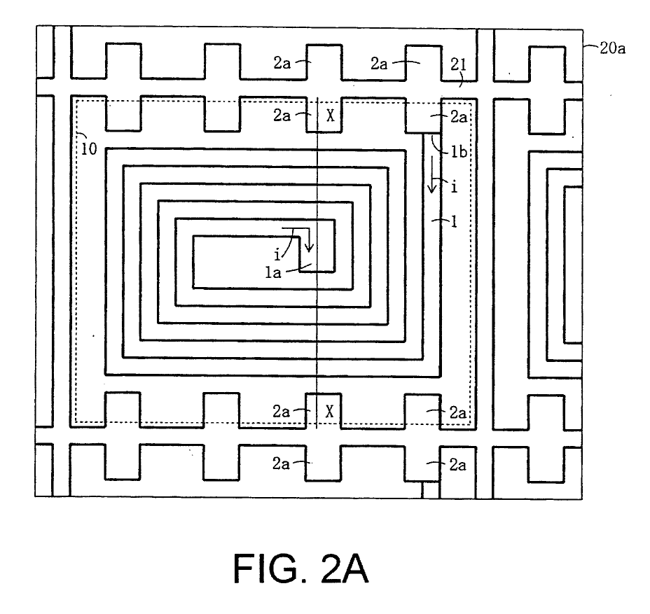

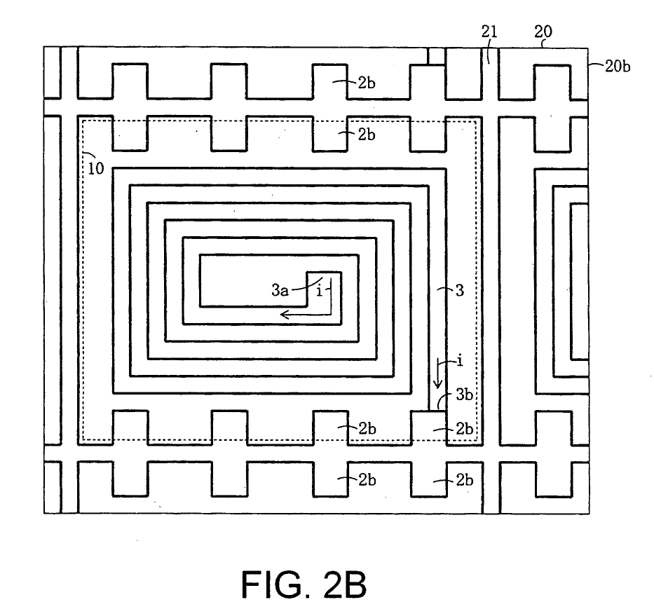

FIGS. 2A and 2B show the configuration of lead frames 20a and 20b. FIG. 2A is a plan view of the lead frame 20a not turned over. FIG. 2B is a plan view of the lead frame 20b turned over.

The terminals 2a and 2b are connected to inside frames 21 of the lead frames 20a and 20b, respectively. The outer end portions lb and 3b of the spiral-shaped first and second coil conductors 1 and 3 are connected to corresponding ones 2a and 2b of the terminals 2a and 2b, respectively.

Directions of flow of current i and directions of magnetic flux Φ are written in FIGS. 1A and 1B. Directions of flow of the current i are written in the first lead frame 20a and the second lead frame 20b turned over as shown in FIGS. 2A and 2B. The directions of flow of the current i in the first coil conductor 1 are equal to the directions of flow of the current i in the second coil conductor 3. That is, current i flowing in the same directions permits density of magnetic flux Φ to increase.

The inlet shown in FIG. 1A is an inlet of current i, so that the terminal 2 located in the inlet serves as an input terminal of current i flowing in the thin inductor. On the other hand, the outlet shown in FIG. 1A is an outlet of current i, so that the terminal 2 located in the outlet serves as an output terminal of current i flowing in the thin inductor.

Incidentally, when two lead frames 20a and 20b are disposed back to back with each other while one of the two lead frames 20a and 20b is turned over as shown in FIGS. 2A and 2B, the two coil conductors 1 and 3 have to be patterned so as to be superimposed over each other. One of the two lead frames may be not turned over but rather 180°-rotated when the two lead frames are disposed back-to-back to each other. In this case, the two coil conductors have to be patterned so as to be superimposed over each other when the two coil conductors are 180°-rotated from each other.

FIGS. 3A to 3D are sectional views (taken along the line X-X in FIG. 2A) successively showing steps of a method of producing the thin inductor depicted in FIGS. 1A and 1B.

In FIG. 3A, two first lead frames 20a, each having a spiral coil conductor 1 and terminals 2a as shown in FIG. 2A, are formed by pressing or etching. One of the two lead frames 20a is turned over so as to be set as a second lead frame 20b (FIG. 2B).

The first lead frame 20a has a first coil conductor 1 and terminals 2a whereas the second lead frame 20b has a second coil conductor 3 and terminals 2b. Connection layers 4 are formed on the central end portion 3a of the spiral of the second coil conductor 3 and on the terminals 2b, respectively. Then, the first and second lead frames 20a and 20b are disposed opposite to each other.

In FIG. 3B, while the first and second lead frames 20a and 20b are superimposed over each other, the end portions la and 3a are fixed to each other and the terminals 2a and 2b are fixed to each other through the connection layers 4 respectively.

The connection layers 4 are laser welding layers, bumps using wires of gold, silver, copper, aluminum or the like used in production of semiconductor, conductive paste layers, ultrasonic bonding layers formed by ultrasonic bonding through a thick film, etc.

In FIG. 3C, the first and second lead frames 20a and 20b fixed to each other are sandwiched between green sheets 5 provided on opposite sides.

In FIG. 3D, a pressure is applied to the green sheets 5. By the pressure, the green sheets 5 are forced into gaps 7 between parts of the first coil conductor 1 and between parts of the second coil conductor 3 and gaps 8 between the first and second coil conductors 1 and 3.

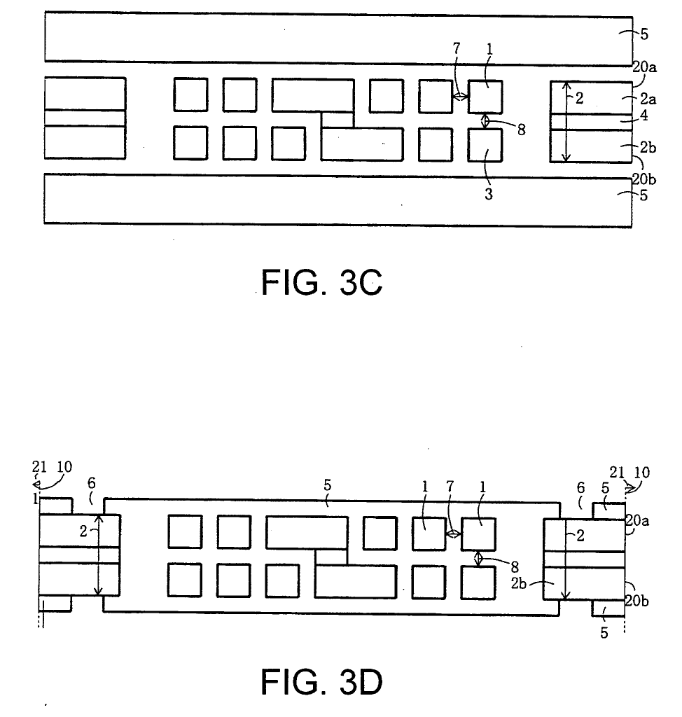

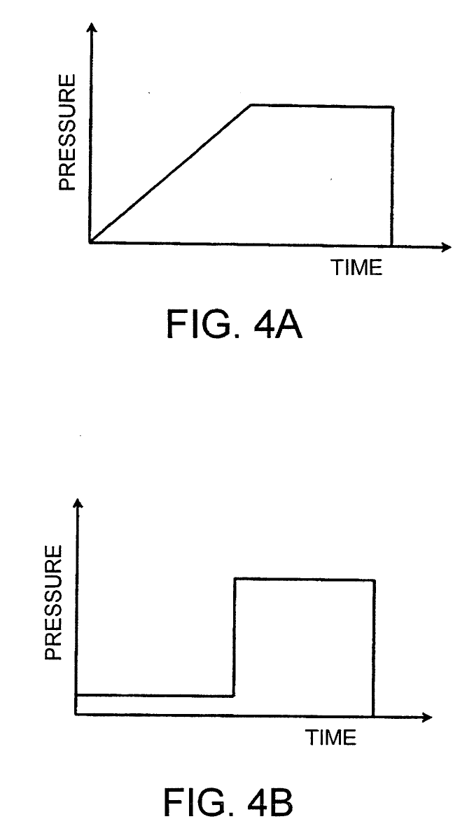

There are two pressure patterns as shown in FIGS. 4A and 4B. FIG. 4A shows the case where pressure increases with passage of time. FIG. 4B shows the case where a high pressure is applied after the gaps are fully filled with the green sheets under a constant low pressure.

Incidentally, the opening portions 6 are formed by using green sheets having holes formed in positions corresponding to the opening portions 6 in advance or by laser-cutting portions corresponding to the opening portions 6 from the green sheets.

Successively, the green sheets 5 are sintered to form a sintered compact. The sintered compact serves as a magnetic substance. Successively, the sintered compact of the green sheets 5, the inside frames 21 of the lead frames 20a and 20b and the connection layer 4 are cut at parting lines 10 so that the frames 21 and the terminals 2 of the coil conductors are divided into halves. Thus, individual thin inductors are formed.

In this manner, use of lead frames as coil conductors permits mechanical strength to be improved, and use of a sintered compact of green sheets as a magnetic substrate permits the substrate to be prevented from breaking or cracking.

In addition, the step of forming through holes in a magnetic substrate by a sandblasting technique according to the background art can be dispensed with, so that reduction in size and cost of an inductor can be attained.

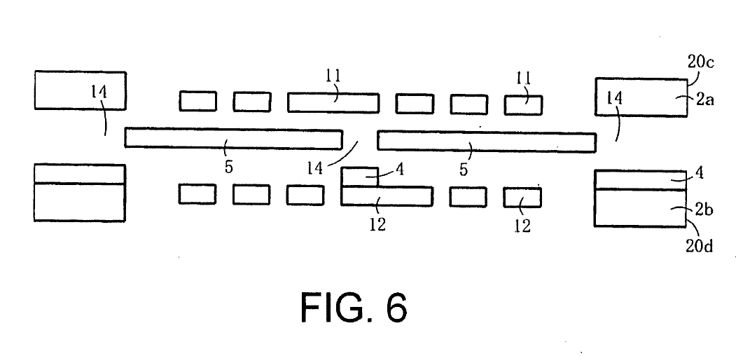

Incidentally, in the step shown in FIG. 3B, a green sheet may be inserted in gaps 8 between the first and second coil conductors 1 and 3 as represented by the step shown in FIG. 6 (which will be described later).

### Embodiment 2

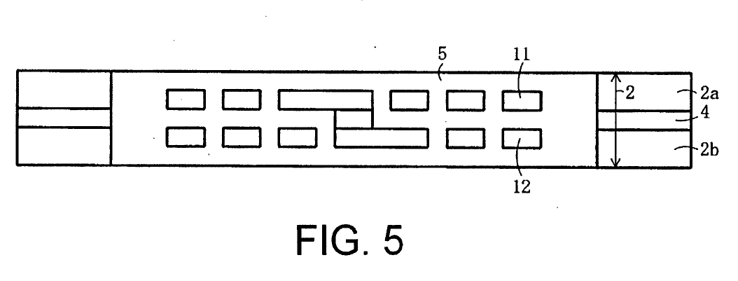

FIG. 5 is a sectional view showing part of a thin inductor according to a second embodiment of the invention. The point of difference of FIG. 5 from FIG. 1B is that only the spiral-shaped first and second coil conductors 1 and 3 are thinned by etching to form first and second coil conductors 11 and 12 at the time of formation of lead frames. Even when the first and second coil conductors 11 and 12 are thinned so that the thickness of the thin inductor is made equal to the thickness of each terminal 2, the first and second coil conductors 11 and 12 can be covered with sintered green sheets 5 (magnetic substance). For this reason, the thickness of the thin inductor shown in FIGS. 1A and 1B can be reduced.

FIGS. 6 to 10 are sectional views of the part successively showing steps of a process for producing the thin inductor depicted in FIG. 5.

In FIG. 6, two first lead frames 20c each having a spiral coil conductor 11 and terminals 2a are formed by pressing or etching. The coil conductor 11 is formed so as to be thinner than the terminals 2a. One of the two first lead frames 20c is turned over to form a second lead frame 20d. The first and second coil conductors 11 and 12 and the terminals 2a and 2b are formed in the first and second lead frames 20c and 20d respectively. Connection layers 4 are formed on a central end portion of the spiral of the second coil conductor 12 and the terminals 2b. Further, a green sheet having through holes 14 capable of being fitted to the connection layers 4 formed on the central end portion of the second coil conductor 12 and the terminals 2b is sandwiched between the first and second coil conductors 11 and 12 so that the first and second lead frames 20c and 20d are disposed opposite to each other.

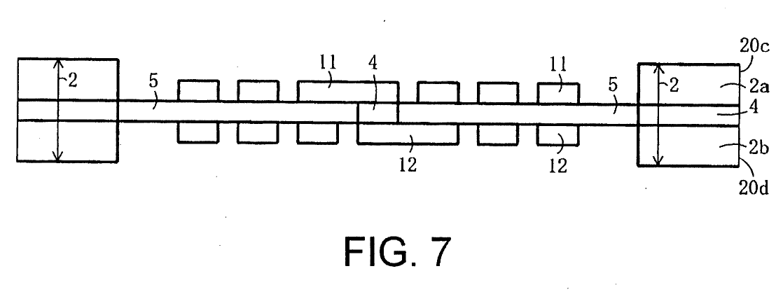

In FIG. 7, while the first and second lead frames 20c and 20d are superimposed over each other, the end portions and the terminals 2a and 2b are fixed to each other through the connection layers 4 respectively.

The connection layers 4 are laser welding layers, bumps using wires of gold, silver, copper, aluminum or the like used in production of semiconductor, conductive paste layers, ultrasonic bonding layers formed by ultrasonic bonding through a thick film, etc.

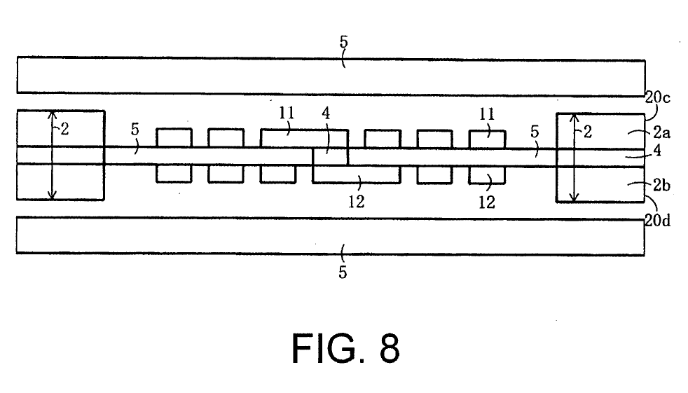

In FIG. 8, the first and second lead frames 20c and 20d fixed to each other are sandwiched between green sheets 5 provided on opposite sides.

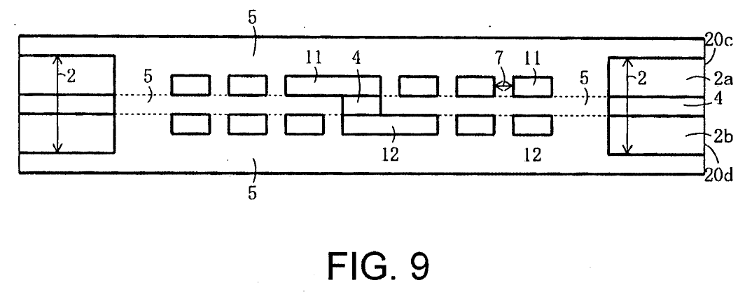

In FIG. 9, a pressure is applied to the green sheets 5. By this pressure, the green sheets 5 are forced into gaps 7 between parts of the first coil conductor 11 and between parts of the second coil conductor 12. Successively, the green sheets 5 are sintered to form a sintered compact. The sintered compact serves as a magnetic substance.

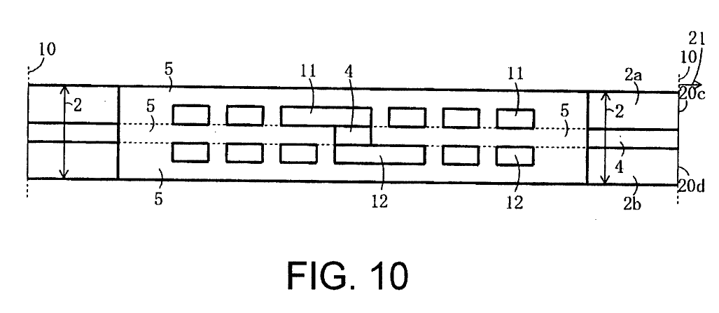

In FIG. 10, surfaces of the sintered green sheet 5 are polished so that the terminals 2 are exposed. Successively, inside frames 21 of the lead frames 20a and 20b and the connection layers 4 are cut at parting lines 10 so that the inside frames 21 and the terminals 2 of the coil conductors are divided into halves. Thus, individual thin inductors are formed.

Incidentally, in the step shown in FIG. 6, the green sheet 5 may be not sandwiched. In this case, a pressure pattern is set as shown in FIG. 4A or 4B in the step shown in FIG. 9.

### Embodiment 3

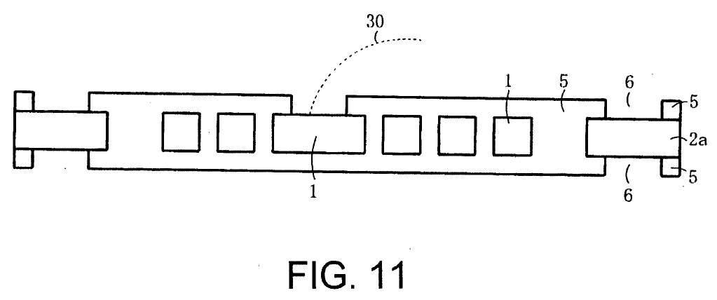

FIG. 11 is a sectional view showing the part of a thin inductor according to a third embodiment of the invention. The point of difference of FIG. 11 from FIG. 1 is that one coil conductor is provided. A central end portion of the spiral-shaped coil conductor 1 is connected to an external connection terminal by a bonding wire 30. Though not shown, the coil conductor 1 may be formed so as to be thin as shown in FIG. 5.

Although the first to third embodiments have been described for the case where a sintered compact of green sheets is used as a magnetic substrate, powder-like magnetic substances may be used in place of the green sheets.

### Embodiment 4

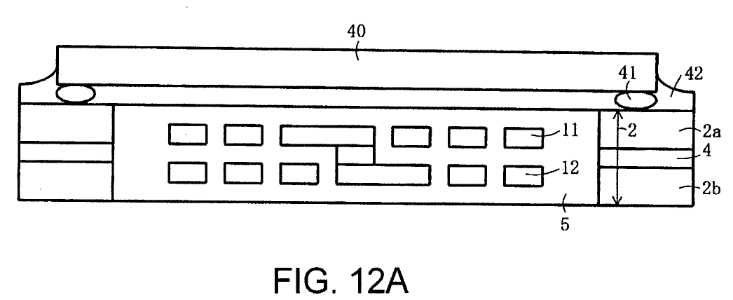

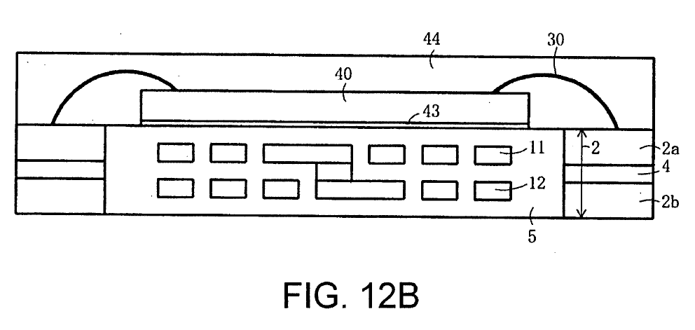

FIGS. 12A and 12B are sectional views of the part showing examples of an ultra small size power conversion apparatus according to a fourth embodiment of the invention. FIG. 12A is a sectional view showing an example in which a semiconductor chip is connected to terminals by bumps. FIG. 12B is a sectional view showing an example in which a semiconductor chip is connected to terminals by bonding wires.

In FIG. 12A, the semiconductor chip 40 is fixed to the terminals 2 of the thin inductor depicted in FIG. 5 by bumps 41 and side surfaces of the thin inductor are covered with underfills 42. Thus, an ultra small size power conversion apparatus is formed.

On the other hand, in FIG. 12B, the semiconductor chip 40 is fixed to the thin inductor depicted in FIG. 5 by an adhesive agent 43, not-shown terminals of the semiconductor chip 40 are connected to the terminals 2 of the thin inductor by bonding wires 30 and a front surface of the semiconductor chip 40 is covered with a sealing resin 44. Thus, an ultra small size power conversion apparatus is formed.

Incidentally, a thin inductor shown in FIG. 1 or 11 may be used as the thin inductor. When the thin inductor shown in FIG. 11 is used, bumps may be preferably used in place of the bonding wires 30 for connecting the thin inductor to the semiconductor chip 40.

What is claimed is:

1. A thin inductor, comprising:
first and second coil conductors each having the same spiral shape and each having a plurality of end portions, the end portions including outer end portions, the first and second coil conductors being superimposed over each other with a gap therebetween;
a connection layer connecting end portions of the first coil conductor to end portions of the second coil conductor; and
a magnetic substance filling gaps between parts of the first coil conductor, gaps between parts of the second coil conductor, and the gap between the first and second coil conductors.

2. A thin inductor according to claim 1, further comprising terminals connected to the outer end portions of the first and second coil conductors.

3. An ultra small size power conversion apparatus comprising a thin inductor according to claim 1, and a semiconductor chip fixed thereto.

4. An ultra small size power conversion apparatus according to claim 3, wherein the semiconductor chip is connected by bumps or bonding wires to the terminals connected to the first and second coil conductors.

5. A thin inductor assembly including first and second lead frames and the thin inductor according to claim 1, the thin inductor further comprising first and second inside frames respectively surrounded by the first lead frame and the second lead frame, wherein the first and second coil conductors are rectangular and respectively connected to the first inside frame and the second inside frame.

6. An ultra small size power conversion apparatus comprising a thin inductor according to claim 5, and a semiconductor chip fixed thereto.

7. A thin inductor assembly including first and second lead frames and the thin inductor according to claim 2, the thin inductor further comprising first and second inside frames respectively surrounded by the first lead frame and the second lead frame, wherein the first and second coil conductors are rectangular and respectively connected to the first inside frame and the second inside frame, wherein the terminals connected to the first coil conductors are rectangular and connected to the first inside frame, and wherein the terminals connected to the second coil conductors are rectangular and connected to the second inside frame.

8. An ultra small size power conversion apparatus comprising a thin inductor according to claim 7, and a semiconductor chip fixed thereto.

9. A thin inductor assembly according to claim 7, wherein the terminals connected to the first coil conductor have the same thickness as the first lead frame, the terminals connected to the second coil conductor have the same thickness as the second lead frame, the first coil conductor has a thickness less than or equal to the thickness of the terminals connected thereto, and the second coil conductor has a thickness less than or equal to the thickness of the terminals connected thereto.

10. A thin inductor assembly including
a thin inductor according to claim 1,
a first lead frame surrounding the first coil conductor and
a second lead frame surrounding the second coil conductor, wherein the magnetic substance surrounds both ends of each of the first and second coil conductors.

11. An ultra small size power conversion apparatus comprising a thin inductor according to claim 10, and a semiconductor chip fixed thereto.

12. A thin inductor according to claim 10, wherein the magnetic substance is a sintered compact of a green sheet or a sintered compact of magnetic powder.

13. A thin inductor according to claim 1, wherein the magnetic substance is a sintered compact of a green sheet or a sintered compact of magnetic powder.

14. A method of producing a thin inductor, comprising the steps of:
surrounding by a first lead frame a first inside frame, and a first spiral-shaped coil conductor and terminals connected thereto;
surrounding by a second lead frame a second inside frame of a shape the same as that of the first inside frame, and a second spiral-shaped coil conductor and terminals connected thereto, the terminals connected to the first coil conductor and the first coil conductor each respectively having the same shape as the terminals connected to the second coil conductor and the second coil conductor;
turning over or rotating by 180° in a planar direction the second lead frame;
forming connection layers on the terminals connected to the second coil conductor and on a central end portion of the second coil conductor;
fixing, via the connection layers, the central end portion of the second coil conductor to a central end portion of the first coil conductor and connecting the terminals connected to the first and second coil conductors to each other, the second lead frame being superimposed on the first lead frame;
inserting the superimposed first and second lead frames in a green sheet;
applying pressure to the green sheet and sintering the green sheet to fill with the green sheet a gap between the first and second coil conductors; and
separating the first and second coil conductors and the terminals connected to the first and second coil conductors from the first and second lead frames.

15. A method of producing a thin inductor according to claim 14, wherein the connection layers comprise one of laser welding layers, ultrasonic bonding layers, bumps, and conductive paste adhesive agent layers.

16. A method of producing a thin inductor according to claim 14, wherein the first and second coil conductors have thickness less than a thickness of the terminals connected to the first and second coil conductors.

17. A method of producing a thin inductor, comprising the steps of:
surrounding by a first lead frame a first inside frame, and a first spiral-shaped coil conductor and terminals connected thereto;
surrounding by a second lead frame a second inside frame of a shape the same as that of the first inside frame, and a second spiral-shaped coil conductor and terminals connected thereto, the terminals connected to the first coil conductor and the first coil conductor each respectively having the same shape as the terminals connected to the second coil conductor and the second coil conductor;
turning over or rotating by 180° in a planar direction the first lead frame;
forming connection layers on the terminals connected to the first coil conductor and on a central end portion of the first coil conductor of the first coil conductor;
disposing a first green sheet on the first coil conductor, the first green sheet having opening portions corresponding to the connection layers;
connecting, via the connection layers, the central end portion of the first coil conductor to a central end portion of the second coil conductor and connecting the terminals connected to the first and second coil conductors to each other, the first lead frame being superimposed on the second lead frame;
inserting the superimposed first and second lead frames in a second green sheet;
applying pressure to the first and second green sheets and sintering the first and second green sheets to fill with the first and second green sheets a gap between the first and second coil conductors; and
separating the first and second coil conductors and the terminals connected to the first and second coil conductors from the first and second lead frames.

18. A method of producing a thin inductor according to claim 17, wherein the connection layers comprise one of laser welding layers, ultrasonic bonding layers, bumps, and conductive paste adhesive agent layers.

19. A method of producing a thin inductor according to claim 17, wherein the first and second coil conductors have a thickness less than a thickness of the terminals connected to the first and second coil conductors.
